(19) United States
(12) Patent Application Publication
(10) Pub. No.: US 2010/0084464 A1
(43) Pub. Date: Apr. 8, 2010

(54) Miniature Transponder and Identification System Including Said Transponder and a Suitable Reader

(75) Inventor: Pascal Veillat, L'etang la Ville (FR)

Correspondence Address: HARNESS, DICKEY & PIERCE, P.L.C., P.O. BOX 828, BLOOMFIELD HILLS, MI, 48303, US

(73) Assignee: LUTRONIC INTERNATIONAL S.A., Rodange (LX)

(21) Appl. No.: 12/516,875

(22) PCT Filed: Nov. 27, 2007
(86) PCT No.: PCT/EP07/62907

§ 371 Date: Aug. 26, 2009

(30) Foreign Application Priority Data
Nov. 30, 2006 (FR) 0655212

(51) Int. Cl. G06F 19/00; G06K 19/067; G06K 7/00

(52) U.S. Cl. 235/385; 235/492; 235/439

(57) ABSTRACT

The transponder contains a winding of conductive wire coiled on a generally cylindrical ferrite bar and connected to an integrated circuit of identification by radiofrequency waves. The winding is made of a single layer of non-contiguous turns, formed with an uninsulated wire, and the integrated circuit is set up to operate at a frequency higher than 10 MHz and is directly attached to the ferrite bar, for example, on a flat part formed at the end of the bar, so as not to exceed the cylindrical volume determined by the bar and the winding. The reader contains a transmitting antenna formed by a flat winding and a receiving antenna with at least two wire assemblies disposed in flat spirals, each assembly containing two flat spirals wound in opposite directions.

### FIELD

The present invention concerns a miniature transponder and an identification system containing such a transponder and an adapted reader, operating according to the radio frequency identification technology known as RFID (Radio Frequency Identification).

### BACKGROUND

An RFID identification system is made up of the transponder and a reading/writing assembly called “reader,” making it possible to ensure exchanges of data with the transponder by radio waves. In general, a transponder contains an electronic circuit or “chip” capable of receiving, storing and/or transmitting data, which communicates with the reader via an antenna connected to said chip. The power necessary for operation of the chip is supplied to the transponder by the reader, which contains for that purpose a transmitting antenna capable of supplying that power and of transmitting data to the transponder, and a receiving antenna capable of receiving the data supplied by the transponder.

The transponders referred to in the invention are, in particular but not limitatively, intended for applications such as animal identification and, for that purpose, intended to be implanted in the body of an animal, generally in direct proximity under its skin.

The system according to the invention is thus notably intended to ensure the identification of very small animals such as mice, finches, tiny fish, etc.

The transponder must then be of very small size and be integrated in an airtight capsule of glass or other biocompatible material, thus enabling its implantation in vivo.

The system can, however, also be used with a view to long-distance identification of any other object or element that cannot integrate the larger-sized existing transponders for reasons of available space, unobtrusiveness, dimensional compatibility, etc.

Such systems are already known, their realization being based on RFID technology operating at frequencies below 1 MHz and generally around 125 KHz or a few hundred KHz at most, as indicated in Patents FR 2,726,926 or EP 258,415. The transponder consists of a winding of several hundred turns of an insulated wire coiled on a ferrite bar and connected to an RFID chip. Such transponders are notably described in U.S. Pat. No. 5,025,550; FR 2,736,240; WO 92/22827; U.S. Pat. No. 5,963,132; WO 87/04900; CA 2,478,975; and U.S. Pat. No. 5,281,855. Owing notably to the large number of winding turns required, the transponder, once encapsulated in a cylindrical glass capsule, occupies a minimum outer space of approximately 2 mm in diameter and 8 mm in length. Furthermore, in the last two documents cited above, the connections between the antenna and the chip use intermediate wiring means such as printed circuits or connection ranges, the unavoidable minimum space of which do not make it possible to reduce sufficiently the general required space of the transponder.

Within the scope of the applications particularly referred to in the present invention, these dimensions remain too large, and it is desirable to be able to reduce them as much as possible. Furthermore, that miniaturization of the transponder poses problems in ensuring good communication between the reader and the transponder and notably requires a transmitting power and, therefore, an intensity of the magnetic field emitted by the reader that is relatively strong in order to ensure operation of the transponder. On the other hand, the return signals emitted by the transponder are of low power and, consequently, the reader must be very sensitive on reception, which raises problems of selectivity owing to the strong transmitting power.

The known technologies do not make it possible to obtain transponders compatible with the applications referred to above, taking into account notably the very small dimensions sought for the transponder and the minimum reading distance imposed by the lack of direct accessibility of the latter.

### SUMMARY

The present invention is intended to solve those problems and is aimed in particular at supplying a very small transponder capable notably of being integrated under the skin of an animal or easily and unobtrusively adapted to different objects. The invention also aims to supply a system adapted to work with such transponders and notably to supply a reader particularly adapted to communicating with these miniaturized transponders.

With these objectives in mind, the object of the invention is a transponder containing a winding of conductive wire coiled on a generally cylindrical ferrite bar and connected to an integrated circuit of identification by radiofrequency waves, characterized in that the winding is made of a single layer of non-contiguous turns, formed with an uninsulated wire, and the integrated circuit is set up to operate at a frequency higher than 10 MHz and is directly attached to the ferrite bar, so as not to exceed the cylindrical volume determined by the bar and the winding.

The operating frequency of the integrated circuit is preferably 13.56 MHz, this frequency being particularly suitable owing to the fact that it is available in the radio frequency spectrum for general use and already currently used in RFID technology for access control or transportation purposes, for example.

Working at high frequency for transmission between transponder and reader makes it possible to use a winding having only a very small number of turns, numbering not more than a few tens, such as about thirty turns. The winding can thus be made with non-contiguous turns and, consequently, with an uninsulated fine wire, which is impossible in the prior art that necessarily requires a large number of turns in contact with one another in superposed layers. An uninsulated gold or aluminum wire of less than 30 μm in diameter can be used, for example, those metals having the advantage, furthermore, of facilitating soldering on the integrated circuit. Creating the winding in a single layer of turns and the use of such an uninsulated wire makes it possible, because of the absence of any insulating coating, to reduce the diametral dimension of the winding and, therefore, of the entire transponder, the diameter of which can be less than 0.7 mm for a maximum length of 4.5 mm, for example.

Thus, when the transponder is encapsulated, the overall dimensions of the capsule can be less than 1 mm in diameter and 6 mm long.

According to a preferential arrangement, the integrated circuit is attached by bonding or soldering on a flat surface formed on the ferrite bar to one of its ends. Also preferentially, that flat surface is a flat part formed in the cylindrical bar roughly on its axis and parallel thereto. That flat surface could also be formed crosswise to the end of the bar. The attachment of the circuit directly on the bar makes it possible to dispense with any other support and, therefore, to avoid the required space generated by the latter. In fact, it is to be noted that, for reasons of transmission with the reader, the volume and therefore the length of the bar must remain sufficient, which allows the use of an end of the bar, axially surpassing the winding, as support of the integrated circuit without increasing the minimum required space of the bar. Furthermore, it is also necessary for at least one end of the bar to surpass the winding in order to secure the bar on the wire coiling operation. Thus, it is possible to let the two ends of the bar axially surpass the winding, one end serving as support for the integrated circuit and the other end serving to grip the bar on winding. It is likewise possible to carry out winding in direct proximity to one end of the bar and to use the other end for support of the circuit and for gripping of the bar, retaining, if need be, a given extra length of the bar, beyond its flat surface of support of the circuit, for gripping or magnetic requirements.

The integrated circuit used is advantageously attached to the bar inside-out, that is, with its connecting terminals situated on the side opposite the surface of the bar on which the circuit is attached. This arrangement makes it possible to dispense with any intermediate connection of the antenna wires, and the latter can thus be soldered or bonded directly on the terminals of the circuit. Furthermore, as the wire is thin and does not contain any insulator, it can thus be precisely positioned on the terminals of the circuit and does not require any connecting plates, as would be necessary if the antenna wire were of greater diameter and/or insulated.

It is to be further noted that, in order to obtain this precise positioning of the wires in relation to the connecting terminals of the circuit, the precise positioning of the circuit can be secured on the soldering or bonding operation, thanks to the fact that it is advantageously arranged for the circuit to be attached on the ferrite bar projecting at least slightly from the axial end of said bar. Accordingly, on the soldering or bonding operation, the precise positioning of the circuit can be secured by mechanical abutment against a fixed marker of the fabricating machine, and this thus gets rid of the slight dimensional defects of the bar. Taking into account the very small dimensions of the elements concerned, this is a great advantage in ensuring a reliable connection between antenna and circuit, avoiding displacements between the position of the ends of the conductors and that of the circuit terminals.

In addition, in order to connect to the integrated circuit the end of the winding situated toward the end of the bar opposite the one bearing said circuit, it is necessary to make a return portion of the conducting wire pass in the axial direction along the bar.

For this purpose, a small flat part can be formed, extending over the length of the bar, of sufficient size to place the return wire there, thus passing inside the turns of the winding without that creating an increase of the radial dimension of the winding. Furthermore, to insulate that return conducting wire portion from the turns, it is provided that said wire portion be covered with an electric insulator in a thin layer of insulating adhesive or thin film, for example. The flat part can also be replaced by a longitudinal groove or incision of V section, for example, at the bottom of which the return wire is lodged. A narrow groove can also be made, just wide enough to pass the return wire, but deeper, so that the return wire will be guaranteed not to enter in contact with the turns and so that it will no longer be necessary to provide an electric insulating layer.

The return conductor can also be passed over the turns, that is, outside the turns. In this case, the turns are wound so as to wed the shape of a flat surface formed on the bar for that purpose, and an insulating varnish or resin ensures the electric insulation between the turns and the return conductor passing over the latter at the level of the said flat part in order not to produce an appreciable extra required space.

The winding with non-contiguous turns can be made by coiling means used in microelectronics, making it possible to ensure the required spacing of the turns, and a varnish can be used to guarantee the spaced positioning of the turns thereafter. One can also form on the ferrite bar a groove or a thread of pitch and depth suitable for receiving the turns of the winding and ensuring their respective positioning and insulation.

The transponder is ordinarily used placed in a capsule, hermetically sealed or not. That capsule can be made of glass or plastic. The protection of the transponder can also be ensured by molding with plastic, resin, silicone, PVC, etc., directly around the transponder, or by an outside coat of varnish.

The invention also concerns an identification system containing such as a transponder and a suitable reader, characterized in that the reader contains a transmitting antenna formed by a flat winding of predetermined diameter and a receiving antenna with at least two wire assemblies disposed in flat spirals, each assembly containing appreciably in the same plane and adjacent to one another two flat spirals wound in opposite directions.

The transmitting antenna and the receiving antenna constituting the radiating element of the reader are preferably made by engraving on the same substrate.

These measures enable optimal operation of the reader by making it possible to adjust the transmission level of the miniature transponder previously defined, that is, to supply a relatively high transmission level, and the receiving and transmitting antennas being arranged so that the receiving antenna will not be blinded by the transmitting part, in order to be able to best discriminate the receiving signal.

In fact, owing to the small dimensions of the transponder, the intensity of the radiation emitted by the reader should be relatively strong, the magnetic field typically having a value ranging between 20 and 30 amperes/meter, that is, 3 to 6 times higher than that of the readers previously known, making possible a reliable remote supply of the transponder. But, on the other hand, owing to the small dimensions of the transponder, the signals returned by the latter are relatively weak.

The geometric shape given the engraving of the antennas makes it possible to minimize at the receiving antenna the electromagnetic fields directly generated by the transmitting antenna and, consequently, to best discriminate the signals coming from the transponder.

The transmitting signal is generated filtered, adjusted and amplified by means of an amplifier of at least class C.

Bandpass filtering makes it possible to filter the signal received on return from the transponder, that filtering being carried out notably so as to preserve only a sideband of the signal received, which is sufficient to obtain the information required from the transponder, but preserving all the power contained in said sideband, so that the information will then be clearly legible by the demodulation circuit.

At the receiving circuit, the voltages in play are very weak, and a preamplification is, therefore, carried out before demodulation of the signal received, the amplifier circuit of the readers making it possible to sufficiently amplify the signal emitted by the transponder in order to obtain error-free reading of the information from said transponder.

### DRAWINGS

Other characteristics and advantages will appear in the description to be made of a transponder according to the invention and of different working variants.

Reference will be made to the attached drawings in which:

FIG. 1 is a view in perspective of the transponder according to the invention;

FIG. 2 is a front end view of the transponder, with a detailed view on an enlarged scale showing the arrangement and insulation of the return wire;

FIG. 3 illustrates the integration of the transponder in an hermetically-sealed glass capsule;

FIG. 4 is a partial view in perspective of a first working variant of the transponder;

FIG. 5 is a view in perspective of a second working variant of the transponder;

FIG. 6 is a view in perspective of the ferrite bar alone for a third working variant of the transponder;

FIGS. 7 to 9 are views corresponding to FIGS. 1 to 3 according to a fourth working variant;

FIG. 10 is a simplified representation of the radiating element of the reader.

### DETAILED DESCRIPTION

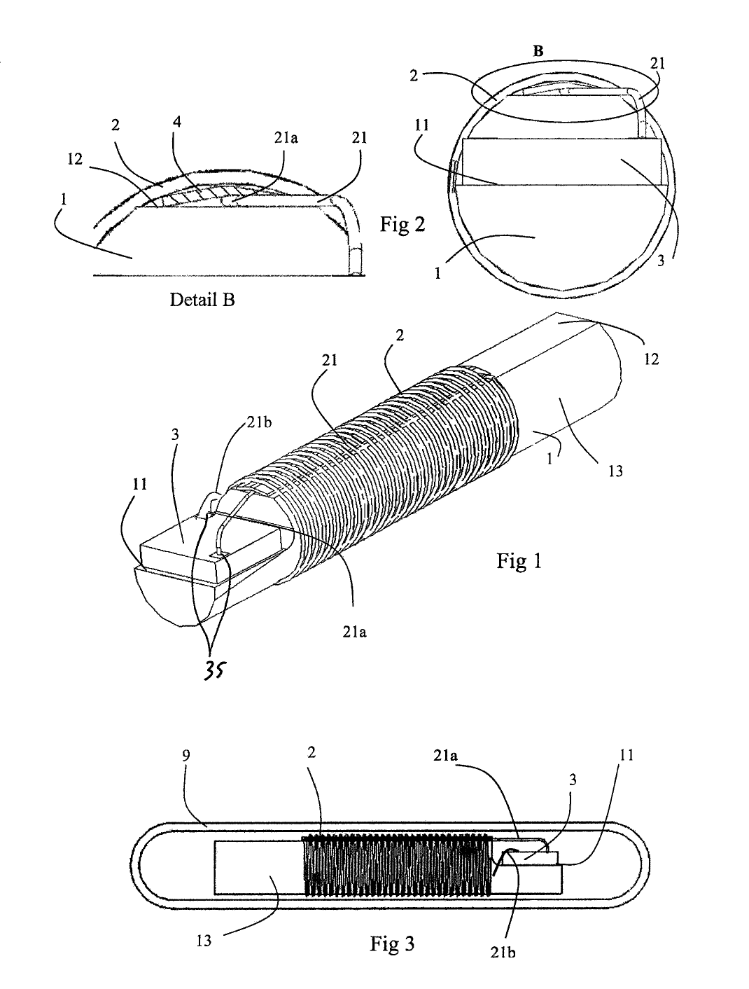

The transponder represented in FIGS. 1 and 2 contains an axially elongated generally cylindrical ferrite bar 1, a winding 2 formed around the bar and an integrated circuit 3 of the type known per se for RFID applications.

The ferrite bar 1 contains at one end a flat part 11, the flat surface of which is situated roughly at the axis of the bar and on which the circuit 3 is attached by bonding or soldering, the electric connecting terminals 35 of the circuit being situated upward, when the bar is positioned as in the figures and making possible the direct soldering of the ends of the winding wires. The bar 1 also contains another flat part 12 which extends over the length of the bar, but of smaller sectional dimension, as will be explained below.

The winding 2 is formed by coiling on the bar 1 several tens of noncontiguous turns of a fine conductive wire 21 without insulation, made of gold, for example. The winding 2 can, for instance, contain about thirty turns of wire 25 μm in diameter, coiled with a suitable pitch of approximately 0.07 mm, for example.

This winding 2 extends from the flat part 11 to its other end, leaving an end portion 13 projecting from the bar, making it possible notably to hold the bar on winding. The end 21b of the conductive wire 21 situated beside the flat part is directly connected by soldering to one of the terminals 35 of the integrated circuit 3. At the other end of the winding, the conductive return wire 21a is folded, passes under the coiled turns along the flat part 12 and is also connected to the circuit 3. A strip of thin insulating film 4 is placed between the return wire 21a and the coiled turns in order to ensure electric insulation. The sectional dimension of the flat part 12 is fixed to match the required sectional space of the return wire and insulating film 4, so that the coiled turns remain at a constant winding radius, without extra thickness on their passage over the return wire. It will also be noted, as can be clearly seen in FIG. 2, that the integrated circuit does not project, when seen in section, beyond the periphery of the winding 2.

In the particular implantable transponder application, the transponder, as defined above, is integrated, as illustrated in FIG. 3 and as already known per se, in a cylindrical glass capsule 9 hermetically sealed at both ends.

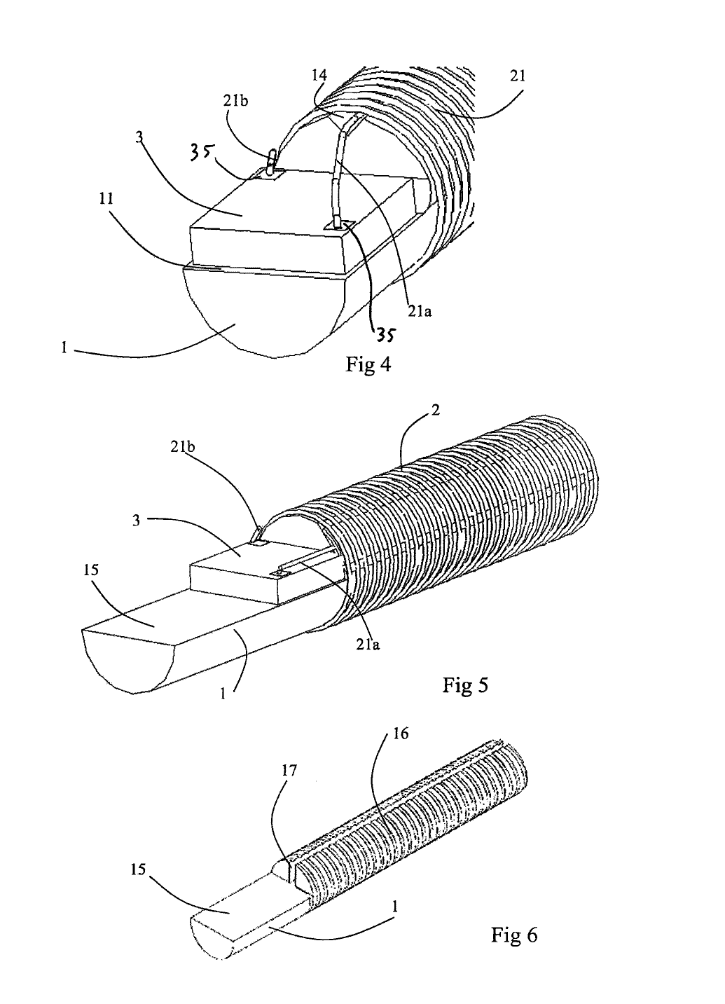

In the variant represented in FIG. 4, the flat part 12 is replaced by a groove 14 of V or U section extending along a generatrix of the cylindrical bar 1, and in which the return wire 21a is lodged. If the depth of that groove is sufficient and possibly by means of punctual maintenance of the return wire at the bottom of the groove by several bonding or varnish points, the use of insulating film can thus be avoided.

In the variant of FIG. 5, the winding is formed from the front face of the bar 1 opposite the end bearing the circuit. The flat part 11 on which the circuit 3 is bonded can then be extended by a free end part 15 serving notably to hold the bar on manufacture of the transponder. It will also be noted in that figure, as a supplementary variant, that the flat part for passage of the return wire 21a is no longer situated, as in FIG. 1, parallel to the flat part 11 supporting the circuit 3, but angularly offset.

FIG. 6, which only shows the ferrite bar 1 without the winding 2 and the integrated circuit 3, also illustrates another variant in which a thread 16, for example 0.05 m deep and of suitable pitch, is created in the bar portion bearing the winding in order to lodge there the wire constituting the turns of the winding. If need be, this thread can moreover also extend over the whole length of the bar, including its end portion containing the flat part. Furthermore, another working variant has been represented in that figure for passage of the return wire 21a, this passage being carried out through a relatively deep groove 17 up to the axis of the bar, for example, and that depth thus avoiding any need for means of holding or insulating the return wire.

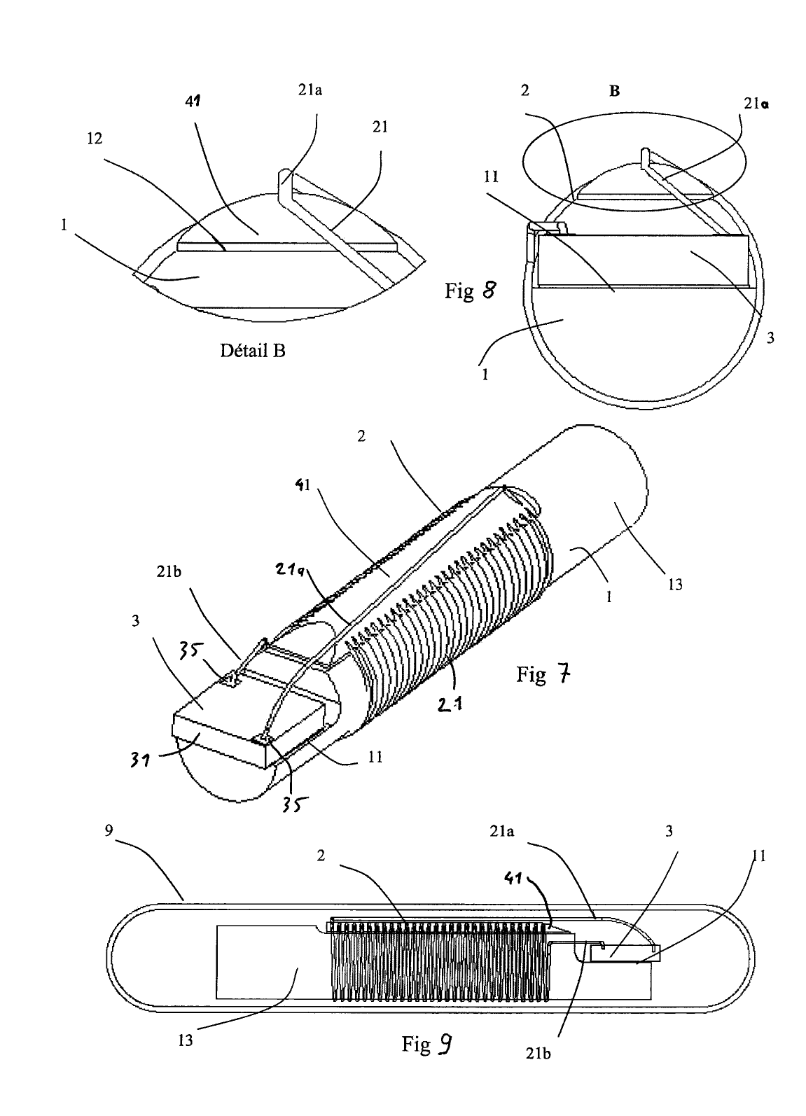

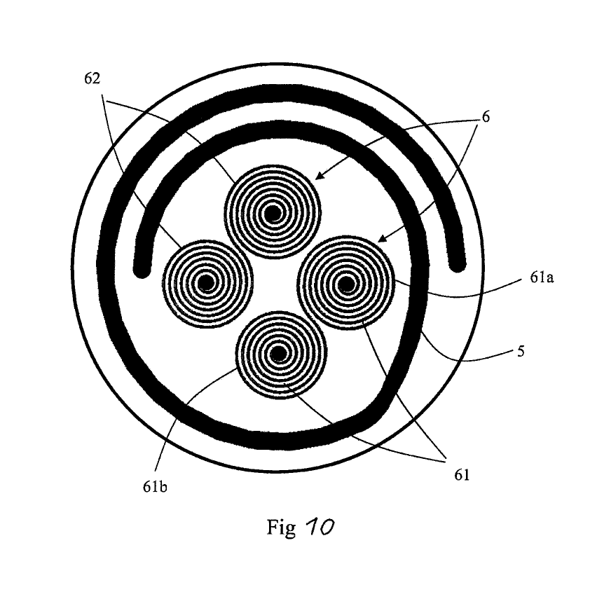

In the working variant of FIGS. 7 to 9, the ferrite bar 1 also contains a flat part 12, the turns of the fine wire 21 are coiled on the wire on being applied against said flat part, and a varnish, adhesive or insulating resin 41 is deposited on the portion of the turns situated at said flat part 12, so as to coat that part of the turns and ensure its electric insulation. The return wire 21a then passes over that insulating coating 41 which, thanks to the fact that it is formed on the flat part 12, does not create a diametral space greater than that of the ferrite bar alone, and therefore neither does the return wire itself create a required space appreciably greater than that of the winding as a whole.

Furthermore, it will be noted that the circuit 3 is attached to the flat part 11 of the bar so as to project slightly beyond the end of the bar. Thus, as has already been explained, the face 31 of the circuit situated toward the axial end of the bar, as well as the edge of the sideface 32 of the circuit, can be used as abutting surfaces for a precise indexing in position of the circuit on the fabricating machine upon soldering of the wires 21a and 21b on the connecting terminals 35, so that, in spite of the extreme fineness of the wires and the small dimension of the terminals or connection ranges, the electric junction can be automatically made very reliably.

The reader adapted to communicate with a transponder according to the invention contains standard electronic elements in order to generate on emission a current making it possible to transmit by radio wave to the transponder the power necessary for operation of its integrated circuit, and in order to combine there the signals sent from the reader to the transponder and, on reception, to detect the return signals and extract from same the information supplied by the transponder. However, as has already been indicated, owing to the marked miniaturization of the transponder according to the invention, the reader had to be improved so as to be able to transmit enough power to the transponder and to read the transponder reliably. For these purposes, the radiating element of the reader according to the invention—and as represented in FIG. 7—essentially consists of a transmitting antenna 5 and a receiving antenna 6 created on the same substrate, for example, by a standard method of making printed circuits. The transmitting antenna 5 consists of some turns of large diameter. The receiving antenna contains two assemblies 61, 62 of conductive tracks arranged in flat spirals inside the turns of the transmitting antenna, each assembly containing, roughly in a same plane and adjacent, two flat spirals 61a, 61b in continuity with one another but wound in opposite directions, the central ends of those spirals being connected moreover to the electronic receiving circuit, not represented in the drawing. This makes possible a reduction of several dB in the direct transmission of the magnetic field of emission to the receiving circuit.

The invention is not limited to the embodiments previously described solely by way of example, nor notably to the particular application of an implantable transponder, especially for small animals. The invention can thus be applied notably to the identification of objets d'art or valuables (paintings, jewels, luxury items, etc.), to the identification of weapons, material for one-time use (endoscope, etc.), and to the industrial tracking of serialized products (electronic maps, electronic pipettes, etc.). In such applications, the transponder module may notably, instead of being placed in a glass sheath, be coated with a non-metallic mechanical protection material like epoxy resin, silicone, PVC or varnish, carbon fiber or Kevlar® or inserted in a non-metallic capsule, whether hermetically sealed or not, depending on the applications.

The invention will be advantageously applied in particular to the identification and tracking of very small laboratory animals, such as baby laboratory mice 5 days old or younger, or 1-day-old rats, for example. The very small dimensions that the invention makes it possible to attain allow for such uses, with no need for suture after injection or anesthesia. The resulting reliability of tracking can, for example, make it possible to dispense with DNA verification operations on some animals.

1. A transponder containing a winding of conductive wire coiled on a generally cylindrical ferrite bar and connected to an integrated circuit of identification by radiofrequency waves, said transponder comprising a winding made of a single layer of non-contiguous turns, formed with an uninsulated wire, and an integrated circuit operating at a frequency higher than 10 MHz, said integrated circuit being directly attached to the ferrite bar, so as not to exceed the cylindrical volume determined by the bar and the winding.

2. The transponder according to claim 1, wherein the winding is made of aluminum or gold wire less than 30 μm in diameter.

3. The transponder according to claim 1, wherein the integrated circuit is attached to a flat surface formed on the ferrite bar toward one of its ends.

4. The transponder according to claim 3, wherein the flat surface is a flat part formed in the cylindrical bar roughly on its axis.

5. The transponder according to claim 3, wherein the integrated circuit includes connecting terminals, said integrated circuit being attached to the bar with its connecting terminals situated on the side opposite the surface of the bar to which the circuit is attached.

6. The transponder according to claim 3, wherein the circuit is attached to the ferrite bar projecting from the axial end of said bar.

7. The transponder according to claim 3, wherein the winding is made in direct proximity to one end of the bar and the integrated circuit is attached to the opposite end of the bar.

8. The transponder according to claim 1, wherein the ferrite bar contains a flat part or a groove extending over the length of the bar and a return wire of the winding which passes over that flat part or in the groove inside the turns of the winding.

9. The transponder according to claim 1, wherein the ferrite bar contains a groove or a thread of pitch and depth adapted to receive the turns of the winding and to ensure that relative positioning and insulation.

10. The transponder according to claim 1, wherein the ferrite bar contains a flat part, the turns of the winding are wound so as to wed the shape of the flat part.

11. The transponder according to claim 1, wherein the transponder is placed in a sealed capsule of glass or plastic.

12. The transponder according to claim 1, wherein the transponder is protected by either coating with a mechanical protection material selected from epoxy resin, silicone, PVC or varnish, or by insertion into a non-metallic capsule or by a combination of coating and insertion into a protection capsule.

13. An identification system containing a transponder according to claim 1 and a reader, wherein the reader contains a transmitting antenna formed by a flat winding of predetermined diameter and a receiving antenna with at least two wire assemblies disposed in flat spirals, each assembly containing appreciably in the same plane and adjacent to one another two flat spirals wound in opposite directions.

14. The identification system according to claim 13, wherein the transmitting antenna and the receiving antenna of the reader are made by engraving on the same substrate.

15. The identification system according to claim 13, wherein the receiving antenna contains two assemblies of conductive tracks disposed in flat spirals inside the turns of the transmitting antenna.

16. The application of the transponder according to claim 1 for the identification and/or tracking of laboratory animals.

17. The application according to claim 16 to the identification and/or tracking of small laboratory animals, such as baby mice and baby rats.

18. The transponder of claim 10 further comprising an insulating varnish or resin applied over the winding to ensure the electric insulation between the turns and the return conductor.
